(19) United States
(12) Patent Application Publication
(10) Pub. No.: US 2023/0249666 A1
(43) Pub. Date: Aug. 10, 2023

(54) CONTROL DEVICE FOR HYBRID VEHICLE

(71) Applicant: TOYOTA JIDOSHA KABUSHIKI KAISHA, Aichi-ken (JP)

(72) Inventors: Takehiro KOMATSU, Toyota-shi (JP); Masahiro KACHI, Nagakute-shi (JP)

(21) Appl. No.: 18/056,720

(22) Filed: Nov. 18, 2022

(30) Foreign Application Priority Data
Feb. 8, 2022 (JP) 2022-017925

(51) Int. Cl. B60W 20/10; B60K 6/26; F02N 11/08

(52) U.S. Cl. CPC B60W 20/10; B60K 6/26; F02N 11/0851; B60K 6/40

(57) ABSTRACT

A control device for a hybrid vehicle that includes an internal combustion engine, a motor, and a clutch provided between the internal combustion engine and the motor includes a first start control unit that starts the internal combustion engine without causing the motor to perform cranking, and a second start control unit that starts the internal combustion engine by causing the motor to perform cranking. After the first start control unit performs start control of the internal combustion engine, the second start control unit starts the internal combustion engine when a crank shall of the internal combustion engine stops for a predetermined time or longer or the crank shaft rotates in an opposite direction to the direction of the cranking.

### CROSS-REFERENCE TO RELATED APPLICATION

This application claims priority to Japanese Patent Application No. 2022-017925 filed on Feb. 8, 2022, incorporated herein by reference in its entirety.

### BACKGROUND

### 1. Technical Field

The present disclosure relates to a control device for a hybrid vehicle.

### 2. Description of Related Art

Some hybrid vehicles are equipped with an internal combustion engine (engine), a motor in a power transmission path between the engine and a wheel and a clutch in the power transmission path between the engine and the motor (for example, Japanese Unexamined Patent Application Publication No. 2020-111276).

### SUMMARY

When an engine start request is made, it is possible that an engine is started only by burning fuel in the engine without causing a motor to perform engine cranking. However, for example, when the rotational speed at the time of the engine start request is low, the start fails. The present disclosure provides a control device for a hybrid vehicle that can prevent a failure occurring when starting an internal combustion engine.

An aspect of the present disclosure is a control device for a hybrid vehicle that includes an internal combustion engine, a motor, and a clutch provided between the internal combustion engine and the motor. The control device includes a first start control unit configured to start the internal combustion engine without causing the motor to perform cranking, and a second start control unit configured to start the internal combustion engine by causing the motor to perform cranking. The second start control unit is configured to, after the first start control unit performs start control of the internal combustion engine, start the internal combustion engine when a crank shaft of the internal combustion engine stops for a predetermined time or longer or when the crank shaft rotates in an opposite direction to a direction of the cranking.

In the aspect, the control device may include a position acquisition unit configured to acquire a position of the crank shaft. The position acquisition unit may reset the position of the crank shaft when the crank shaft rotates in a reverse direction.

It is possible to provide a control device for a hybrid vehicle capable of preventing a failure occurring when starting an internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a hybrid vehicle;

FIG. 2 is a schematic configuration diagram of an engine; and

FIG. 3 is a flowchart illustrating a process performed by an ECU.

### DETAILED DESCRIPTION OF EMBODIMENTS

### Hybrid Vehicle

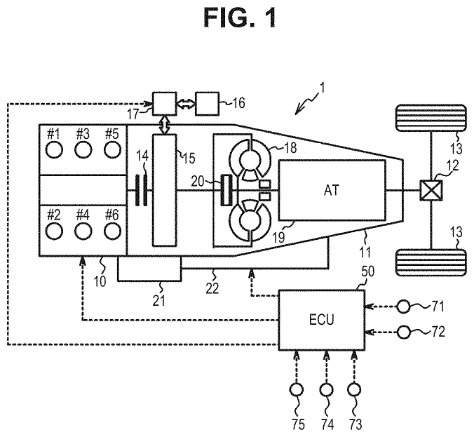

FIG. 1 is a schematic diagram illustrating a hybrid vehicle 1. The hybrid vehicle 1 is equipped with an engine 10 (internal combustion engine) and a motor 15 as drive sources. The hybrid vehicle 1 is provided with a K0 clutch 14, the motor 15, a torque converter 18, and an automatic transmission 19 in that order along a power transmission path from the engine 10 to wheels 13. The engine 10 may be, for example, a V6 engine, that has six cylinders #1 to #6. The engine 10 may be, for example, a V engine or a straight engine. The engine 10 may be a gasoline engine or a diesel engine. The number of cylinders of the engine 10 may be plural, for example, four or six, or may be one. The K0 clutch 14, the motor 15, the torque converter 18, and the automatic transmission 19 are provided in a transmission unit 11. The transmission unit 11 and the left and right wheels 13 are drive-connected via a differential gear 12.

The K0 clutch 14 is provided between the engine 10 and the motor 15 on the same power transmission path. The state of the K0 clutch 14 is switched to one of a released state, a slip state, and an engaged state according to the supply of hydraulic pressure. Specifically, when the K0 clutch 14 is in the released state, the hydraulic pressure supply causes it to be in the slip state or the engaged state, and the power transmission between the engine 10 and the motor 15 is connected. Further, the K0 clutch 14 becomes the released state when the hydraulic pressure supply is stopped, and cuts off the power transmission between the engine 10 and the motor 15. The slip state is a state in which an engaging element on the engine 10 side of the K0 clutch 14 and an engaging element on the motor 15 side are in sliding contact with each other with a predetermined rotational speed difference. The engaged state is a state in which both engaging elements of the K0 clutch 14 are connected and the engine 10 and the motor 15 have the same rotational speed. The released state is a state in which both engaging elements of the K0 clutch 14 are separated from each other.

The motor 15 is connected to a battery 16 via an inverter 17. The motor 15 functions as a motor that generates a driving force for the vehicle in response to electric power supplied from the battery 16, and also functions as a generator that generates electric power that charges the battery 16 in response to power transmission from the engine 10 and the wheel 13. The electric power transferred between the motor 15 and the battery 16 is adjusted by the inverter 17.

The inverter 17 is controlled by the ECU 50 described below, and either converts a direct voltage from the battery 16 into an alternating voltage, or converts an alternating voltage from the motor 15 into a direct voltage. In the case of a power running operation in which the motor 15 outputs torque, the inverter 17 converts the direct voltage of the battery 16 into the alternating voltage to adjust the electric power supplied to the motor 15. In the case of a regenerative operation in which the motor 15 generates electric power, the inverter 17 converts the alternating voltage from the motor 15 into the direct voltage to adjust the electric power supplied to the battery 16.

The torque converter 18 is a fluid joint having a torque amplification function. The automatic transmission 19 is a stepped automatic transmission that switches the gear ratio in multiple stages by switching gear stages. The automatic transmission 19 is provided between the motor 15 and the wheel 13 on the power transmission path. The motor 15 and the automatic transmission 19 are connected via the torque converter 18. The torque converter 18 is provided with a lockup clutch 20 that receives hydraulic pressure and is in an engaged state to directly connect the motor 15 and the automatic transmission 19.

The transmission unit 11 is further provided with an oil pump 21 and a hydraulic control mechanism 22. The hydraulic pressure generated by the oil pump 21 is supplied to the K0 clutch 14, the torque converter 18, the automatic transmission 19, and the lockup clutch 20, respectively, via the hydraulic pressure control mechanism 22. The hydraulic control mechanism 22 is provided with hydraulic circuits for each of the K0 clutch 14, the torque converter 18, the automatic transmission 19, and the lockup clutch 20, and various hydraulic control valves for controlling their hydraulic pressure.

The hybrid vehicle 1 is provided with an electronic control unit (ECU) 50 as a control device. The ECU 50 is an electronic control unit including an arithmetic processing circuit that performs various arithmetic processing related to vehicle travel control, and a memory in which programs and data for the control are stored. The ECU 50 is an example of a control device for a hybrid vehicle. The ECU 50 functions as a first start control unit that starts the engine 10 without causing the motor 15 to perform cranking, as a second start control unit that starts the engine 10 by performing cranking, and as a position acquisition unit that acquires a crank angle that is a position of a crank shaft 33 detected by a crank angle sensor 72.

The ECU 50 controls the drive of the engine 10 and the motor 15. For example, the ECU 50 controls the torque and the rotational speed of the engine 10 by controlling the throttle opening, the ignition time, and the fuel injection amount of the engine 10. Further, the ECU 50 controls the drive of the K0 clutch 14, the lockup clutch 20, and the automatic transmission 19 through the control of the hydraulic control mechanism 22. The ECU 50 controls the hydraulic pressure applied to the K0 clutch 14 by using the hydraulic pressure control mechanism 22, and changes the state of the K0 clutch 14 to control the cranking torque transmitted from the motor 15 to the engine 10.

The ECU 50 controls the rotational speed and torque of the motor 15 by controlling the inverter 17 to adjust the amount of electric power exchanged between the motor 15 and the battery 16. Further, as will be described in detail below, the ECU 50 controls the electric power supplied from the motor 15 to the battery 16 by the inverter 17 such that the motor braking torque in the regenerative operation becomes a target value.

Signals from an ignition switch 71, a crank angle sensor 72, a motor rotational speed sensor 73, an air flow meter 74, and an accelerator opening sensor 75 are input to the ECU 50. The crank angle sensor 72 detects the rotational speed of the crank shaft 33 of the engine 10. The crank shaft 33 has, for example, a plurality of protrusions (not illustrated) arranged along a rotation direction, and has a portion of a notch in which the protrusions are not provided. The crank angle sensor 72 is, for example, an electromagnetic sensor, and detects a crank angle based on a change in voltage due to rotation of the crank shaft 33. The motor rotational speed sensor 73 detects the rotational speed of an output shaft of the motor 15. The air flow meter 74 detects the intake air amount of the engine 10. The accelerator opening sensor 75 detects the opening degree of the accelerator pedal, which is the amount by which a driver presses the accelerator pedal.

The ECU 50 drives the hybrid vehicle in either a motor mode or a hybrid mode. In the motor mode, the ECU 50 releases the K0 clutch 14 and drives the hybrid vehicle by the power of the motor 15. In the hybrid mode, the ECU 50 engages the K0 clutch 14 and drives the hybrid vehicle by at least the power of the engine 10. The hybrid mode includes a mode in which the hybrid vehicle travels using only the power of the engine 10, and a mode in which the motor 15 is driven by power running and the hybrid vehicle travels using both the engine 10 and the motor 15 as power sources.

The switching of the traveling mode is performed based on the required driving force of the vehicle obtained from the vehicle speed and the opening degree of the accelerator, the charging state of the battery 16, and the like. For example, when the required driving force is relatively small and the state of charge (SOC) indicating the remaining charge of the battery 16 is relatively high, the motor mode in which the engine 10 stops is selected in order to improve fuel efficiency. When the required driving force is relatively large or the SOC of battery 16 is relatively low, the hybrid mode in which at least the engine 10 is driven is selected.

In the hybrid mode, the ECU 50 performs intermittent operation control for automatically stopping the engine 10 when a predetermined stop condition is satisfied and restarting the automatically stopped engine 10 when a predetermined restart condition is satisfied. For example, when the accelerator opening degree becomes zero in the hybrid mode, the ECU 50 automatically stops the engine 10 assuming that an automatic stop condition is satisfied. Further, when the accelerator opening degree becomes larger than zero, the ECU 50 automatically restarts the engine 10 assuming that a restart condition is satisfied. When the engine 10 is automatically stopped, the ECU 50 releases the K0 clutch 14 to stop the fuel injection. When the engine 10 is automatically restarted, the ECU 50 cranks the engine 10 by the motor 15 via the K0 clutch 14 to start fuel injection and ignition, and then engages the K0 clutch 14.

### Engine

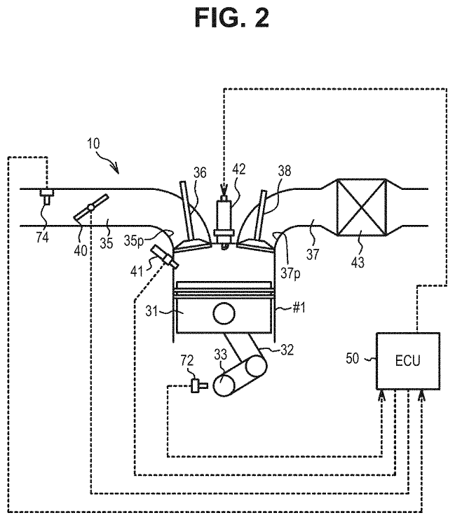

FIG. 2 is a schematic configuration diagram of the engine 10, and illustrates one cylinder #1 of a plurality of cylinders of the engine 10. The engine 10 has a piston 31, a connecting rod 32, the crank shaft 33, an intake passage 35, an intake valve 36, an exhaust passage 37, and an exhaust valve 38. The air-fuel mixture is burned inside the cylinder. The piston 31 is accommodated in the cylinder #1 so as to be reciprocating, and is connected to the crank shaft 33, which is the output shaft of the engine 10, via the connecting rod 32. The connecting rod 32 and the crank shaft 33 convert the reciprocating motion of the piston 31 into the rotational motion of the crank shaft 33.

The intake passage 35 is connected to an intake port 35p of the cylinder #1 via the intake valve 36. The exhaust passage 37 is connected to an exhaust port 37p of the cylinder #1 via the exhaust valve 38. The intake passage 35 is provided with the above-described air flow meter 74 and the throttle valve 40 for adjusting the intake air amount. The exhaust passage 37 is provided with a catalyst 43 for purifying the exhaust gas.

The cylinder #1 is provided with an in-cylinder injection valve 41. The in-cylinder injection valve 41 injects fuel directly into the cylinder #1. In addition to the in-cylinder injection valve 41, or in place of the in-cylinder injection valve 41, a port injection valve that injects fuel toward the intake port may be provided. The cylinder #1 is provided with an ignition device 42 that ignites a mixture of intake air introduced through the intake passage 35 and fuel injected by the in-cylinder injection valve 41 by spark discharge, The other cylinders of the engine 10 have similar configurations.

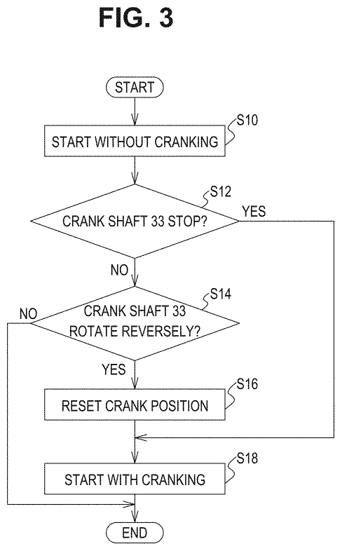

FIG. 3 is a flowchart illustrating a process performed by the ECU 50, which is the process of starting the engine 10. There are controls for starting of the engine 10 without causing the motor 15 to perform cranking and for starting of the engine 10 with cranking. In the process of FIG. 3, first, the ECU 50 controls the start of the engine 10 without cranking (step S10). When the rotational speed of the engine 10 at the start of the start control is high, the start without cranking is likely to be successful. On the other hand, when the rotational speed is low, the start is likely to fail.

The ECU 50 determines whether the crank shaft 33 has stopped for a predetermined time or longer (step S12). In the case of an affirmative determination (Yes), the start of the engine 10 has failed. Then, the ECU 50 performs step S18 described below. In the case of a negative determination (No), the ECU 50 acquires the crank angle from the crank angle sensor 72 and determines whether the crank shaft 33 is rotating in a reverse direction (step S14). When the negative determination is made in both steps S12 and S14, the engine 10 has been successfully started without cranking, and the process ends.

For example, when ignition is performed when the piston 31 is located on a retard side the top dead center (TDC), the crank shaft 33 rotates in the reverse direction (affirmative determination in step S14). In this case, the ECU 50 resets the crank position. The ECU 50 sets the crank angle acquired from the crank angle sensor 72 as an initial value, and re-detects the crank angle from, for example, the position of the notch of the crank shaft 33.

After the affirmative determination in step S12 or step S16, the ECU 50 starts the engine 10 with cranking (step S18). The hydraulic pressure of the K0 clutch 14 becomes high, and torque is transmitted from the motor 15 to the engine 10 via the K0 clutch 14, and thus the crank shaft 33 rotates. This completes the process.

According to the present embodiment, the ECU 50 implements the start control of the engine 10 without performing cranking (step S10). The start of the engine 10 may fail, and the crank shaft 33 may stop, or the crank shaft 33 may rotate in the reverse direction (steps S12 and S14). When the start without cranking fails, the ECU 50 performs start control accompanied by cranking to start the engine 10 (step S18). By trying to start independently without cranking and, when it fails, starting with cranking, it is possible to prevent the failure occurring when starting.

When the start fails, the crank shaft 33 may rotate in a direction that is opposite to the intended direction (step S14). Due to the reverse rotation, there may be a difference between the actual position (actual crank angle) of the crank shaft 33 and the crank angle acquired by the ECU 50. The ECU 50 can acquire an accurate crank angle by resetting the crank angle.

In the example described above, the hybrid vehicle 1 is controlled by the single ECU 50. The embodiment is not limited to this, and the above-described control may be performed by a plurality of ECUs such as an engine ECU for controlling the engine 10, a motor ECU for controlling the motor 15, and a clutch ECU for controlling the K0 clutch 14.

The preferred embodiment of the present disclosure is described in detail above. However, the present disclosure is not limited to the specific embodiment, and various modifications and changes can be made within the scope of the gist of the present disclosure described in the claims.

What is claimed is:

1. A control device for a hybrid vehicle that includes an internal combustion engine, a motor, and a clutch provided between the internal combustion engine and the motor, the control device comprising:
a first start control unit configured to start the internal combustion engine without causing the motor to perform cranking; and
a second start control unit configured to start the internal combustion engine by causing the motor to perform cranking,
wherein the second start control unit is configured to, after the first start control unit performs start control of the internal combustion engine, start the internal combustion engine when a crank shaft of the internal combustion engine stops for a predetermined time or longer or when the crank shaft rotates in an opposite direction to a direction of the cranking.

2. The control device according to claim 1, further comprising a position acquisition unit configured to acquire a position of the crank shaft,
wherein the position acquisition unit is configured to reset the position of the crank shaft when the crank shaft rotates in a reverse direction.
